(19) United States
(12) Patent Application Publication
(10) Pub. No.: US 2004/0135336 A1
(43) Pub. Date: Jul. 15, 2004

(54) Skid steer vehicle with steerable laterally-extending suspensions

(75) Inventors: Anthony J. Lamela, Gilberts, IL (US); Brian E. Felsing, Park Ridge, IL (US); Troy D. Bateman, Plainfield, IL (US)

Correspondence Address: CASE NEW HOLLAND INC., CNH - IP LAW DEPARTMENT, BOX 1895 MS 641, NEW HOLLAND, PA, 17557, US

(73) Assignee: Case, LLC

(21) Appl. No.: 10/743,960

(22) Filed: Dec. 22, 2003

Related U.S. Application Data
(63) Continuation-in-part of application No. 10/136,129, filed on May 1, 2002.

(51) Int. Cl. B60G 1/00

(52) U.S. Cl. 280/124.1

(57) ABSTRACT

A skid steer vehicle has a chassis with an engine mounted thereon and is supported by four suspensions located at the left front, the left rear, the right front and the right rear of the vehicle. The suspensions include control arms that extend laterally away from the vehicle that are connected to struts for steering the vehicle. Wheels are connected to the struts to support the vehicle. Two wheels on the left side of the vehicle are driven by a first hydraulic motor and two wheels on the right side of the vehicle are driven by a second hydraulic motor. The wheels can be steered such that the front wheels point to the left and the rear wheels point to the right, and such that the front wheels point to the right and the rear wheels point to the left.

### RELATED APPLICATIONS

This application is a continuation-in-part of, and claims 35 USC 120 priority to, U.S. patent application Ser. No. 10/136,129 for a “Skid Steer Loader” to Brian E. FELSING, Anthony J. LAMELA, and Troy D. BATEMAN, filed on May 1, 2002 and published on Nov. 6, 2003 as Publication Number US 2003/0205424 A1.

### FIELD OF THE INVENTION

This invention relates to skid steer vehicles having sprung suspensions. More particularly, it relates to skid steer vehicles having steerable and laterally-extending suspensions.

### BACKGROUND OF THE INVENTION

Skid steer vehicles were devised some thirty years ago to provide a small, highly maneuverable work vehicle that could operate in close cooperation with workers at a worksite.

The classic skid steer vehicle has an implement, such as a bucket or pavement breaker disposed at the front of the vehicle that extends from one or two pivoting arms.

The vehicle itself rests on a chassis from which four or six wheels extend, generally all the same size, to support the vehicle and drive the vehicle over the ground.

In its original configuration, the wheels of the skid steer vehicle were ganged together in an unusual arrangement: the wheels on one side of the vehicle were linked to be driven together at the same speed by one drive motor, and the wheels on the other side of the vehicle were linked to be driven together by another drive motor.

The movement of the wheels on each side of the vehicle were independent of each other: the operator can, by a variety of devices, rotate the wheels on one side of the vehicle at one speed and in one direction, and also rotate the wheels on the other side of the vehicle at another speed, and (if desired) in another direction.

In this manner, the skid steer vehicle can be driven forward or backward, but at another extreme, can be rotated in place without moving forward or backward, by the expedient of rotating the wheels on opposing sides of the vehicle in opposite directions at the same speed. Any intermediate motion between these extremes is also provided by the traditional system.

To turn a traditional skid steer vehicle one rotates the wheels on opposing sides of the vehicle in opposite directions (for turning in place) or at different speeds (for more gradually turning). This movement at different speeds or in different directions causes the wheels to skid across the ground. This skid steering occurs when a wheel moves with respect to the ground along a vector that is not perpendicular to the axis of the wheel's rotation.

Conventional skid steer vehicles travel at relatively low speeds, ranging up to 6-12 mph maximum. Skid steer vehicles are limited to these speeds because they historically lack sprung suspensions. Skid steer vehicles lack sprung suspensions primarily because of their intended design as small, inexpensive vehicles capable of travel around relatively small worksites that steer by skidding. Given the size, cost, speed and steering constraints, a sprung suspension was unnecessary and even a limitation in many uses.

This inability to operate above 6 mph is becoming a problem in the construction industry. Current skid steer vehicle engines have enough power to drive skid steer vehicles over the ground at higher speeds. The ride at these higher speeds can be quite rough, however, since the conventional skid steer vehicles lack a suspension.

There is a need for a skid steer vehicle that travels faster to cover more ground during a typical work day. There is a need for a suspended skid steer vehicle to permit this faster movement. There is also a need for a steerable skid steer vehicle suspension that is small and compact and that provides both conventional and skid steering.

It is an object of this invention to provide such a vehicle and suspension.

### SUMMARY OF THE INVENTION

In accordance with a first aspect of the invention, a skid steer vehicle is provided having a chassis, at least one left side drive motor at least one right side drive motor, and four suspensions including right front, right rear, left front and left rear suspensions, wherein the two left suspensions are pivotally coupled to the chassis, wherein the two left suspensions extend leftwardly and laterally away from the chassis, and wherein the two left suspensions are both drivingly coupled to the at least one left side motor to be driven at the same rotational speed, wherein the two right suspensions are pivotally coupled to the chassis, wherein the two right suspensions extend rightwardly and laterally away from the chassis, and wherein the two right suspensions are both drivingly coupled to the at least one right side motor to be driven thereby at the same rotational speed.

### BRIEF DESCRIPTION OF THE DRAWINGS

Other objects of the present invention and many of the attendant advantages of the present invention will be readily appreciated as the same becomes better understood by reference to the following detailed description when considered in connection with the accompanying drawings, in which like reference numerals designate like parts throughout the figures thereof and wherein:

FIG. 1 is a left side view of a skid steer vehicle in accordance with the present invention.

FIG. 2 is a partial cross sectional top view of the skid steer vehicle of FIG. 1 taken generally along section line 2-2 and showing the preferred arrangement of four steerable suspensions, the chain tank and the left and right side drive motors with wheels and the upper portion of the struts removed for clarity.

FIG. 3 is a left side view of the left front suspension of the vehicle of FIGS. 1 and 2 showing the control arm arrangement with the left front wheel removed for ease of viewing. This arrangement is the same for all four suspensions.

FIG. 4 is a front view of the left front suspension of the vehicle of the foregoing FIGURES taken at section line 4-4 in FIG. 2 with the left front wheel removed for ease of viewing

FIG. 5 is a schematic illustration of the motor drive hydraulic circuit of the skid steer vehicle of FIGS. 1-3.

FIG. 6 is a schematic illustration of the hydraulic steering circuit for steering the suspensions of the vehicle of the foregoing FIGURES.

### DETAILED DESCRIPTION OF THE INVENTION

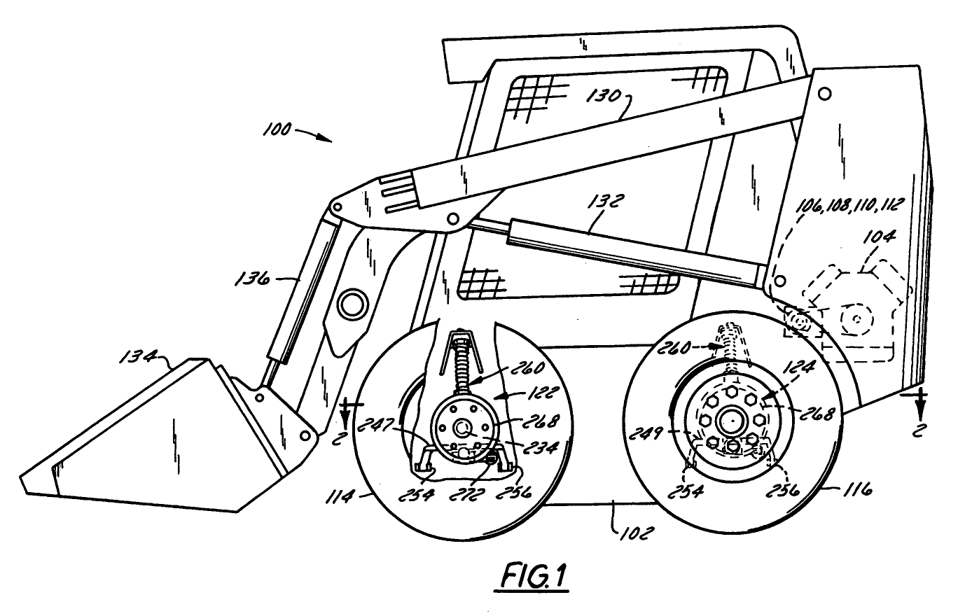

FIG. 1 illustrates a skid steer vehicle 100 having a chassis 102 and an engine 104 mounted thereon. The engine is coupled to and drives four hydraulic pumps including a left side hydraulic pump 106, a right side hydraulic pump 108, a hydraulic charge pump 110 and a hydraulic steering pump 112.

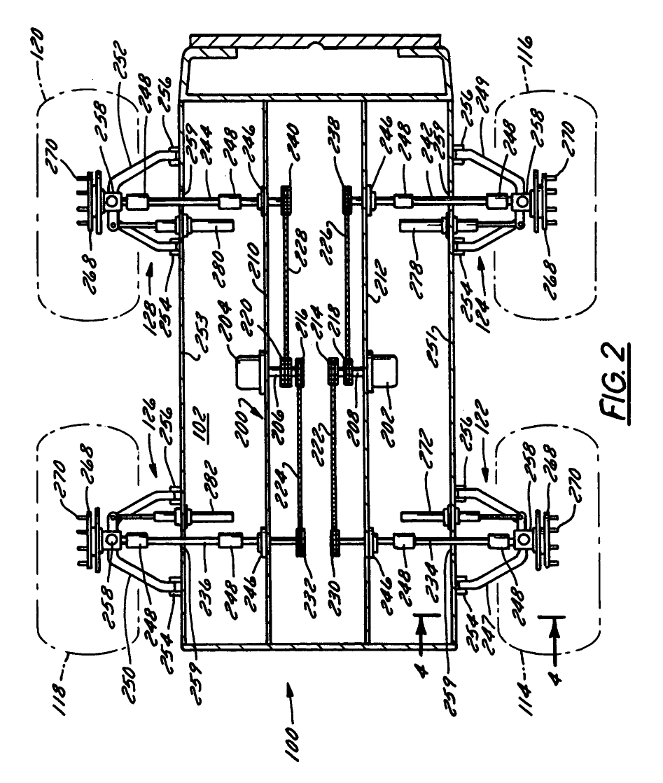

The chassis 102 is supported on four wheels including a left front wheel 114, a left rear wheel 116, a right front wheel 118 (FIG. 2) and a right rear wheel 120 (FIG. 2). Wheels 114, 116, 118, and 120 are rotationally coupled to and driven by suspensions 122, 124, 126, and 128, respectively.

Left and right side loader lift arms, including left side loader lift arm 130, are pivotally coupled to the chassis 102. Left and right hydraulic lift cylinders, including left hydraulic lift cylinder 132 are coupled to and between the loader lift arms and the chassis to raise and lower the lift arms with respect to the chassis.

A bucket 134 is pivotally coupled to the end of the loader lift arms to pivot with respect thereto. Left and right bucket cylinders, including pictured left bucket cylinder 136, are coupled to and between bucket 134 and the left and right loader lift arms, respectively, to pivot the bucket with respect to the cylinder.

The right side of vehicle 100 (not illustrated in FIG. 1) is configured with a right side bucket cylinder, a right side loader lift arm and a right side hydraulic lift cylinder identically arranged as the pictured a left side bucket cylinder, left side loader lift arm and left side hydraulic lift cylinder.

Engine 104 is preferably an internal combustion engine such as a gasoline or diesel engine.

Left and right side hydraulic pumps 106 and 108 are preferably independently actuatable bi-directional variable displacement pumps—pumps that can be separately actuated to vary the flow rate of fluid through the pumps and also the flow direction.

The vehicle's load is transferred from the chassis through the suspensions and to wheels, which support the vehicle for travel over the ground. The wheels may be solid or pneumatic. They may be elastomeric or metal or a combination thereof. They are preferably all the same size and rotate at the same speed on each side of the vehicle. If the wheels on one side of the vehicle are of different overall diameter, they are driven by their respective motors on each side at different angular velocities such that the speed at their outer diameters (i.e. their over the ground speed) is the same.

FIG. 2 illustrates the vehicle in cross-section. It shows the structures of the suspension and drive system that drive the wheels in rotation and support the chassis on the wheel.

In the central portion of the vehicle's chassis 102 is a chain tank 200. There are two motors, left drive motor 202 and right drive motor 204 that drive the let and right side wheels, respectively.

The left and right motors have shafts 206, 208 that extend through chain tank sidewalls 210, 212. Sprockets 214, 216, 218, 220 are coupled to and driven by the shafts. Sprockets 214, 216 engage and drive forwardly extending chains 222, 224, and sprockets 218, 220 engage and drive rearwardly extending chains 226, 228.

Chains 222, 224 extend forward from sprockets 214, 216 and engage sprockets 230, 232 which are coupled, respectively, to forward drive shafts 234, 236. Shaft 234 extends laterally outward from the chain tank to the left and shaft 236 extends laterally outward from the chain tank to the right. Shaft 234 is drivingly coupled to left front wheel 114. Shaft 236 is drivingly coupled to right front wheel 118. The chains are comprised of chain links.

Chains 226, 228 extend rearward from sprockets 214, 216 and engage sprockets 238, 240 which are coupled, respectively, to rear drive shafts 242, 244. Shaft 242 extends laterally outward from the chain tank to the left and shaft 244 extends laterally outward from the chain tank to the right. Shaft 242 is drivingly coupled to left rear wheel 116. Shaft 244 is drivingly coupled to right rear wheel 120. The chains are comprised of chain links.

Shafts 234, 236, 242, and 244 are supported by bearings 246 at their inner ends where they pass through the sidewalls of the chain tank. Shafts 234, 236, 242 and 244 include flexible couplings 248 along their length to more easily accommodate the relative movement of the wheels they drive.

Alternative arrangements include providing four drive motors, wherein each suspension is provided with a drive motor to drive its respective drive shaft. In this manner the drive chains and multiple sprockets can be eliminated.

Suspensions 122, 124, 126 and 128 include control arms 247, 249, 250, and 252, respectively, that are coupled to and pivot up and down with respect to chassis 102. These control arms are coupled to the chassis at forward pivot 254 and at rearward pivot 256, which are located on chassis 102 sidewalls 251 and 253, and which constrain the control arms to pivot up and down at their laterally extending outer ends 258 about a longitudinal and generally horizontal axis with respect to the chassis.

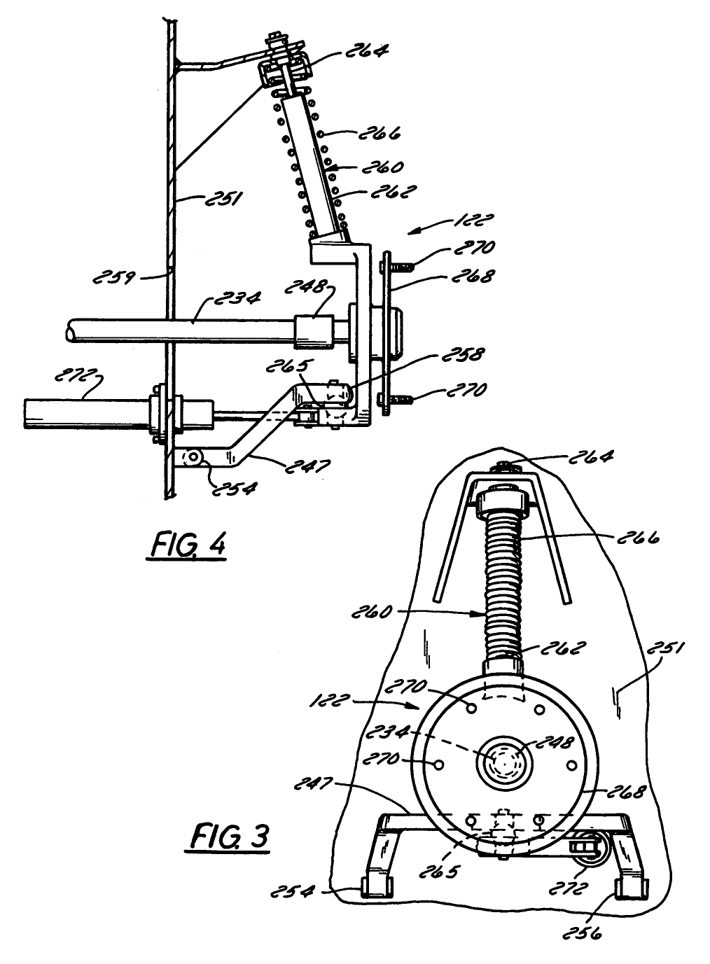

FIGS. 3 and 4 illustrate the left front suspension, which is the same as all the other suspensions of the vehicle in its operation and construction. The right side suspensions are mirror images of the left side suspensions and the rear suspensions are mirror images of the front suspension.

While FIGS. 3 and 4 illustrate the control arm arrangement of the left front suspension, they apply equally to the other suspensions of the vehicle, which are therefore not separately described herein.

The outer end 258 of left front control arm 247 is coupled to a strut 260 that extends upward from the control arm and is coupled to chassis 102. The strut comprises an outer cylindrical portion 262 and an inner rod portion 264 that slides within the cylindrical portion 262. A spring 266 is coiled around strut 260 to keep strut 260 extended. Spring 260 engages the cylindrical portion of the strut at its lower end and the vehicle chassis at its upper end, thereby supporting the weight of the vehicle.

The cylindrical portion and the rod portion of strut 260 may be configured not merely to slide, one within the other, but to function as a hydraulic spring or a hydraulic damper, or as a combined hydraulic spring and damper.

Strut 260 supports drive shaft 234 for rotation, holding the end of driveshaft 234 generally horizontal and parallel to the ground. The outer end of drive shaft 234 has a flange 268 with studs 270 extending therefrom to which wheel 114 is mounted.

When the vehicle chassis moves downward closer to the ground and the suspensions compress, the ground forces wheel 114 upward causing control arm 247 to pivot with respect to chassis 102 about the longitudinal and horizontal axis defined by forward pivot 254 and rearward pivot 256. As control arm 247 pivots upward, strut 260 supports the drive shaft, permitting the outer end of the drive shaft and the wheel to move upward as the inner rod portion collapses into the cylindrical portion, and permitting drive shaft 234 to move up and down in slot 259 in sidewall 251 when the left front suspension moves up and down. The chassis 102 sidewalls at the other three suspensions have similarly located slots to accommodate upward and downward movement of their associated drive shafts.

Strut 260 is coupled to the outer end 258 of the control arm by a ball joint 265 that provides two degrees of freedom, permitting the lower portion of strut 260 to be steered about a generally vertical axis, and permitting the strut to hold driveshaft 234 generally horizontal whenever control arm 247 pivots upward or downward.

Strut 260 is steered by steering actuator 272, which is coupled to strut 260 and chassis 102. Steering actuator 272 pivots strut 260 about a generally horizontal axis causing the wheel to steer to the left, to the right, or straight ahead.

Steering actuator 272 is preferably a hydraulic cylinder that extends and retracts as hydraulic fluid is conducted into its extend and retract ports, respectively.

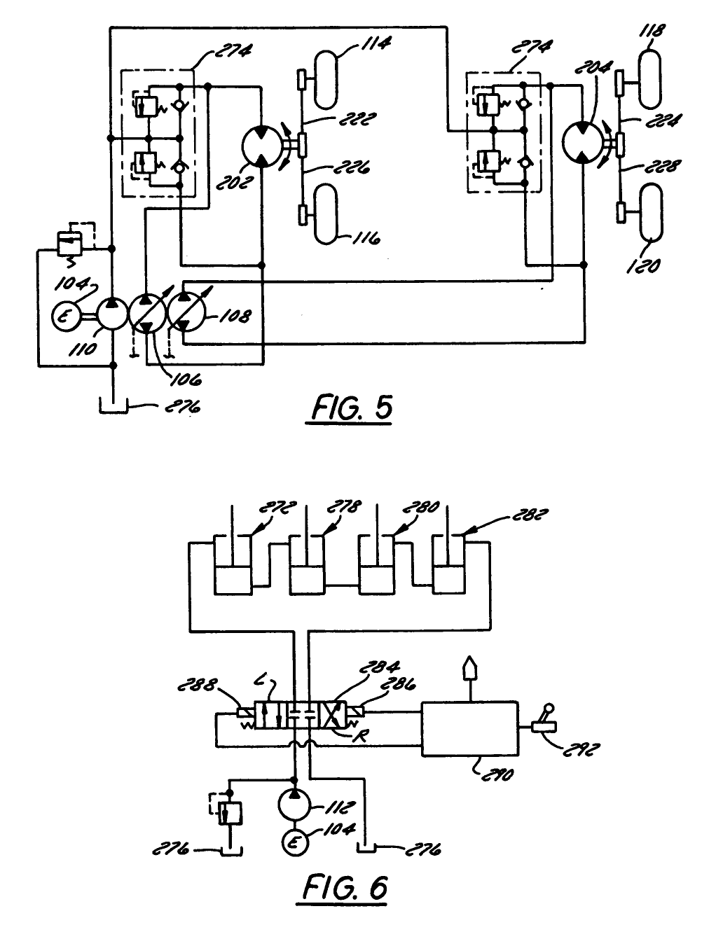

FIG. 5 is a schematic diagram of the hydraulic circuit that couples the left pump 106 and the right pump 108 to left and right side hydraulic drive motors 202, 204, respectively.

Left side hydraulic drive pump 106 is coupled in series with left side hydraulic motor 202 to drive hydraulic motor 202 and, through the left side sprocket, chain and drive shaft arrangement, to drive both of the left wheels simultaneously and in the same direction. Similarly, right side hydraulic drive pump 108 is coupled in series with right side hydraulic motor 204 to drive hydraulic motor 204 and, through the right side sprocket, chain and drive shaft arrangement, to drive both of the right side wheels simultaneously and in the same direction.

Pumps 106 and 108 are bidirectional—they can drive hydraulic fluid under pressure in both directions through the pump. As a result, they can drive their respective motors in both directions. Both the left and the right side drive pumps are variable displacement pumps that can be separately controlled by the operator. This independent and separate control permits the operator to drive the wheels on opposing sides of the vehicle in different directions, or in the same direction. It also permits the operator to drive the wheels on opposing sides of the vehicle at different speeds as well. The operator provides these different speed and different direction by electronically or manually changing the displacement of the pumps using manual or electronic actuators that are known in the art.

Pump 106 and motor 202 form a first series drive circuit. Pump 108 and motor 204 form a second series drive circuit that is independent of the first series drive circuit.

Each of these drive circuits has a hydraulic fluid makeup and pressure relief circuit 274. Whenever the pressure in either of the series drive circuits drops below a minimum design pressure, circuits 274 supply make-up hydraulic fluid from hydraulic charge pump 110. Whenever the hydraulic fluid pressure in the series drive circuits rises above a maximum design pressure, circuits 274 dump hydraulic fluid from the series drive circuits to tank 276.

FIG. 6 is a schematic diagram of the hydraulic circuitry that coupled to and controls the four steering actuators associated with each of the four suspensions. Actuator 272 steers the left front suspension Actuator 278 steers the left rear suspension. Actuator 280 steers the right rear suspension and actuator 282 steers the right front suspension. These four actuators are coupled together in series with steering valve 284, which, in turn, is in fluid communication with tank 276 and steering pump 112.

Steering valve 284 directs hydraulic fluid into the four steering actuators to steer them left and right with respect to chassis 102. The steering actuators are coupled together such that both the front wheels turn to the left and both the rear wheels turn to the right simultaneously when steering valve 284 is moved to its left (“L”) position. Similarly, both the front wheels are turned to the right and both the rear wheels are turned to the left simultaneously when steering valve 284 is moved to its right (“R”) position. Valve 284 is actuated electrically, as shown here, by solenoids 286 and 288. Solenoid 286 moves valve 284 to the right and solenoid 288 moves valve 284 to the left. Alternatively, valve 284 may be actuated mechanically, pneumatically or hydraulically.

In place of the single valve 284 illustrated herein, alternative arrangements may include a plurality of valves coupled to the actuators in place of valve 284. Each of these valves may separately control the flow of fluid to and from each actuator. In addition, position sensors may be provided to indicate the actual position of the actuators, thereby permitting a control circuit (either electrical, mechanical, hydraulic or pneumatic, or a combination thereof) to coordinate the steering of each actuator with the other actuators. Other familiar hydraulic circuit elements such as pressure relief valves and makeup circuits may also be combined with the circuit elements of FIG. 6.

One preferred means for actuating the solenoids includes an electronic controller 290. Electronic controller 290 includes a microprocessor, RAM, ROM and driver circuits coupled together with control, address and data buses to drive the solenoids of valve 284 and to control the displacement of hydraulic drive pumps 106 and 108. The controller is configured by programmed instructions in ROM, causing controller 290 to respond to operator manipulation of joystick 292 by changing the wheels speed and direction of rotation, and by steering the wheels with respect to the chassis.

When the operator manipulates joystick 292, controller 290 is configured by its programmed instructions to responsively steer the vehicle by controlling the steering actuators. It is also programmed to responsively skid steer and drive the vehicle by controlling pumps 104 and 106, to which it is operatively coupled.

In response to operator joystick 292 commands, controller 290 is configured to steer the vehicle as a conventional vehicle by energizing the solenoids of valve 284, thereby turning the wheels to steer left and right, while simultaneously driving all the wheels in forward or all in reverse. Controller 290 is also configured to skid steer the vehicle, by driving the wheels on one side in a direction or at a speed different than the wheels on the other side of the vehicle. Controller 290 does this by changing the displacement of the hydraulic drive pumps 106 and 108 to which it is coupled. Controller 290 is also configured to steer all four wheels into straight ahead positions when the controller is in the skid steering mode by controlling the position of valve 284 to which it is coupled.

It will be understood that changes in the details, materials, steps, and arrangements of parts which have been described and illustrated to explain the nature of the invention will occur to and may be made by those skilled in the art upon a reading of this disclosure within the principles and scope of the invention. The foregoing description illustrates the preferred embodiment of the invention; however, concepts, as based upon the description, may be employed in other embodiments without departing from the scope of the invention. Accordingly, the following claims are intended to protect the invention broadly as well as in the specific form shown.

We claim:

1. A skid steer vehicle having a longitudinally extending axis, a left side, a right side, a front end and a rear end, the vehicle comprising:
a chassis;
an engine supported by the chassis;
a plurality of hydraulic pumps coupled to and driven by the engine, the plurality of pumps including a left side drive pump, a right side drive pump and a steering pump;
at least one left side hydraulic drive motor and at least one right side hydraulic drive motor coupled to the left side and the right side hydraulic drive pumps, respectively; and
four vehicle suspensions, said suspensions being disposed at the left front, the right front, the left rear and the right rear of the vehicle, wherein each suspension includes a control arm pivotally coupled to the chassis to pivot with respect to the chassis about a longitudinally extending axis, a spring for supporting the vehicle; a strut coupled to the control arm, and a wheel coupled to the strut to be steered thereby,
wherein the left side drive motor is drivingly coupled to the two wheels of the left front and the left rear suspensions and wherein the right side drive motor is drivingly coupled to the two wheels of the right front and the right rear suspensions.

2. The skid steer vehicle of claim 1, wherein the control arms pivot about horizontal axes.

3. The skid steer vehicle of claim 2, wherein the control arm of each suspension is coupled to the chassis of the vehicle at two points, including a first point disposed forward of the strut of said each suspension and a second point disposed rearward of the strut of said each suspension.

4. The skid steer vehicle of claim 2, the vehicle further comprising first chain links coupled to the at least one left side drive motor and the wheels of the left front and the left rear suspensions.

5. The skid steer vehicle of claim 4, the vehicle further comprising second chain links coupled to the at least one right side drive motor and the wheels of the right front and the right rear suspensions.

6. The skid steer vehicle of claim 5, wherein the control arms of the four suspensions extend laterally away from the vehicle, the two left side suspension control arms extending leftwardly and laterally away from the left side of the chassis, and the two right side control arms extending rightwardly and laterally away from the right side of the chassis.

7. The skid steer vehicle of claim 6, wherein the left side of the chassis includes a generally vertically and longitudinally extending left side wall and wherein the right side of the chassis includes a generally vertically and horizontally extending right side wall, and further wherein the left front and left rear suspension control arms are mounted adjacent to the left sidewall and the right front and right rear suspensions are mounted adjacent to the right sidewall.

8. A skid steer vehicle having a longitudinally extending axis, a left side, a right side, a front end and a rear end, the vehicle comprising:
a chassis;
a power source supported on the chassis;
a plurality of hydraulic pumps coupled to and driven by the power source, the plurality of pumps including a variable displacement left side drive pump, a variable displacement right side drive pump and a steering pump;
at least one left side hydraulic drive motor and at least one right side hydraulic drive motor coupled to the left side and the right side hydraulic drive pumps, respectively; and
at least four vehicle suspensions, said suspensions being disposed at the left front, the right front, the left rear and the right rear of the vehicle, wherein each of said at least four suspensions includes a laterally-extending control arm attached to the chassis to pivot about a longitudinal axis, a spring, a strut coupled to the control arm, and a wheel drivingly coupled to one of the left side drive motor and the right side drive motor.

9. The skid steer vehicle of claim 8, wherein the left side drive motor is drivingly coupled to the wheels of the left front and the left rear suspensions, and wherein the right side drive motor is drivingly coupled to the wheels of the right front and the right rear suspensions.

10. The skid steer vehicle of claim 9, wherein the control arms of all four suspensions pivot about horizontal axes.

11. The skid steer vehicle of claim 10, wherein the control arm of each suspension is coupled to the chassis of the vehicle at a first point disposed forward of the strut of said each suspension and a second point disposed rearward of the strut of said each suspension.

12. The skid steer vehicle of claim 11, the vehicle further comprising first chain links coupled to the at least one left side drive motor and the wheels of the left front and the left rear suspensions.

13. The skid steer vehicle of claim 12, the vehicle further comprising second chain links coupled to the at least one right side drive motor and the wheels of the right front and the right rear suspensions.

14. The skid steer vehicle of claim 13, wherein the two left side suspension control arms extend leftwardly away from the left side of the chassis, and the two right side control arms extend rightwardly away from the right side of the chassis.

15. The skid steer vehicle of claim 14, wherein the left side of the chassis includes a generally vertically and longitudinally extending left side wall and wherein the right side of the chassis includes a generally vertically and horizontally extending right side wall, said left and right sidewalls extending substantially the entire length of the chassis

16. The skid steer vehicle of claim 15, wherein the left front and left rear suspension control arms are mounted to the left sidewall and wherein the right front and right rear suspensions are mounted to the right sidewall.

17. The skid steer vehicle of claim 8, further comprising steering actuators coupled to the four wheels and the steering pump, the actuators being configured to simultaneously steer the front wheels to the left and the rear wheels to the right, and to simultaneously steer the front wheels to the right and the rear wheels to the left.

18. The skid steer vehicle of claim 17, further comprising at least one hydraulic valve in fluid communication with the steering pump and the steering actuators to control the flow of fluid therebetween.
